(19) United States
(12) Patent Application Publication
(10) Pub. No.: US 2026/0023030 A1
(43) Pub. Date: Jan. 22, 2026

(54) Electromagnetic Imaging for Large Storage Bins Using Ferrite Loaded Shielded Half-Loop Antennas

(71) Applicants: GSI Electronique Inc, St-Hubert (CA); University of Manitoba, Winnipeg (CA)

(72) Inventors: Taghi Cena Mohamadi, Winnipeg (CA); Mohammad Asefi, Winnipeg (CA); Colin Gerald Gilmore, Winnipeg (CA)

(21) Appl. No.: 18/993,170

(22) PCT Filed: Jul. 14, 2023
(86) PCT No.: PCT/IB2023/057214

§ 371 Date: Jan. 10, 2025

Related U.S. Application Data
(60) Provisional application No. 63/369,710, filed on Jul. 28, 2022.

(30) Foreign Application Priority Data
Jul. 28, 2022 (CA) 3169353

(51) Int. Cl. G01N 22/04; H01Q 1/22; H01Q 7/06

(52) U.S. Cl. CPC G01N 22/04; H01Q 1/22; H01Q 7/06

(57) ABSTRACT

In one embodiment, a method implemented by an electromagnetic imaging system for imaging material within a metal container, the method comprising: transmitting to. and receiving signals from, a plurality of antennas attached to an interior wall of the metal container, the signals delivered over a plurality of channels, each of the plurality of antennas comprising a ferrite loaded, shielded half-loop antenna; measuring a plurality of scattering parameters (S-parameters) for all of the plurality of channels; calibrating the measurements; and providing an image of the material using an inversion algorithm based on the calibrated measurements.

### TECHNICAL FIELD

The present disclosure is generally related to electromagnetic imaging of containers.

### BACKGROUND

Electromagnetic Imaging (EMI) involves interrogating a target with electromagnetic fields, measuring its response, and using an inversion algorithm to convert these measurements into an image of that target. A recent application of EMI is monitoring grain in storage containers, where multiple antennas transmit and receive electromagnetic signals into the mass of stored grain. These containers are typically metallic grain storage containers (grain bins), which may be modelled as a perfect electric conductor chamber (partially) filled with a lossy dielectric. The electromagnetic fields are generated and detected via an array of antennas that surround the imaging target. The measured fields are then run through an inversion algorithm, which determines the volume, height, cone shape, and relative permittivity of the grain. The relative permittivity of the grain may be used to indicate moisture content of the grain, an important property for safe, long-term storage.

The actual measurements taken from such EMI systems are called Scattering parameters (S-parameters), which are typically measured using a Vector Network Analyzer (VNA). For instance, the VNA transmits energy through a switch and a series of long cables going to each antenna. For microwave networks that have two ports, a network may be fully characterized by taking four S-parameters (S11, S21, S12, and S22). The inversion algorithms, used to generate the images of the grain properties, as described above, usually only use the scattering parameter, S21, measured by the VNA. Industrial use of such systems tend to use low cost electronics, and as such, commercial EMI systems for bin monitoring use a partial VNA that only measures S11 and S21 (but not S12 and S22). These VNAs are available at a reduced cost compared to a full 2-port VNA.

The individual performance of each antenna can strongly affect the imaging results. For example, most inversion algorithms assume the measurement of an electromagnetic field at a point and make assumptions about exact knowledge of the incident field. Antennas that do not match these assumptions can lead to poor or useless inversion results.

Given design goals that include (a) measuring the fields at a point, and (b) generating an incident field that is well modelled by a magnetic dipole point source, previous work in the industry (see, e.g., M. Asefi, et. al. “Surface-current measurements as data for electromagnetic imaging within metallic enclosures” IEEE Transactions on Microwave Theory and Techniques 64, no. 11 (2016): 4039-4047.R) lead to the development of a shielded half-loop antenna (SHLA) that measures the surface current (proportional to the magnetic field tangential to the bin wall behind the antenna). By installing the antennas on the metallic wall of the grain bin, it is possible to use the image theorem in electromagnetics (see, e.g., Harrington, R. F. “Time-harmonic electromagnetic fields/Harrington RF—New-York, Chichester.” (2001)) and halve the loop to make a Shielded Half Loop Antenna (SHLA). These antennas have been used extensively in industrial grain bin EMI. Existing SHLAs satisfy the design requirements above, but have a very high S11 parameter (e.g., on the order of −1 or −2 dB). That is, most incoming waves from the source (e.g., from the VNA) are reflected from the SHLA antennas and are not radiated into the bin, which results in a lower signal S21 parameter and thus lower signal-to-noise ratio for the inversion algorithm.

### SUMMARY

Some embodiments include a system including a metal container configured to store a material, a measurement system comprising a vector network analyzer (VNA), a switch module, a plurality of cables, the metal container, and a plurality of antennas coupled to an interior wall of the metal container, wherein the switch module is configured to switch signals transmitted to and received from the plurality of antennas via a plurality of channels, wherein the VNA is configured to measure scattering parameters (S-parameters) of all of the plurality of channels, and wherein each antenna of the plurality of antennas comprises a ferrite loaded, shielded half-loop antenna. The system may further include a controller operably coupled to the measurement system, and the controller may include at least one processor and at least one non-transitory computer-readable storage medium storing instructions thereon that, when executed by the at least one processor, cause the system to: receive measurements via the measurement system, calibrate the received measurements, and generate an image of the material using an inversion algorithm based on the calibrated measurements.

The ferrite loaded, shielded half-loop antenna may include a base portion comprised of ferrite material, the base portion adjacent to and in contact with the interior wall of the metal container.

The interior wall of the metal container may constitute a ground plane for the ferrite loaded, shielded half-loop antenna.

The ferrite loaded, shielded half-loop antenna may further include a solid conductor attached at each end of the conductor to the interior wall of the metal container, wherein the solid conductor spans over the base portion, separated from, and elevated above, only a partial region of the base portion by a gap extending between the two ends of the conductor.

The partial region may include a middle region of the base portion.

The ferrite loaded, shielded half-loop antenna further comprises a shielding material covering the solid conductor except with a gap in coverage centrally located at a portion of the solid conductor that spans over the base portion.

One or more embodiments of the disclosure include a method implemented by an electromagnetic imaging system for imaging a material within a metal container. The method may include transmitting to, and receiving signals from, a plurality of antennas attached to an interior wall of the metal container, the signals delivered over a plurality of channels, each of the plurality of antennas comprising a ferrite loaded, shielded half-loop antenna, measuring a plurality of scattering parameters (S-parameters) for all of the plurality of channels, calibrating the measurements, and generating an image of the material using an inversion algorithm based on the calibrated measurements.

The ferrite loaded, shielded half-loop antenna comprises a base portion comprising a slab of ferrite material, the base portion adjacent to and in contact with the interior wall of the metal container.

The interior wall may constitute a ground plane for the ferrite loaded, shielded half-loop antenna.

The base portion may be used for impedance matching of the plurality of antennas.

The ferrite loaded, shielded half-loop antenna further may include a solid conductor attached at each end of the conductor to the interior surface of the container, wherein the solid conductor spans over the base portion, separated from, and elevated above, only a partial region of the base portion by a gap extending between the two ends of the conductor.

The partial region may include a middle portion of the base portion.

The ferrite loaded, shielded half-loop antenna further may include a shielding material covering the solid conductor except with a gap in coverage centrally located at a portion of the solid conductor that spans over the base portion.

The method may further include improving a signal to noise ratio of an S21 parameter based on the ferrite loading, the improvement over a non-ferrite loaded shield half-loop antenna for the same parameter.

The method may further include shifting a resonance frequency lower in frequency based on the ferrite loading, the lowering of the resonance frequency relative to a resonance frequency for a non-ferrite loaded shield half-loop antenna.

Some embodiments include an antenna including a base portion comprised of ferrite material, a solid conductor attached at each end of the conductor to the interior surface of the container, wherein the solid conductor spans over the base portion, separated from, and elevated above, only a partial region of the base portion by a gap extending between the two ends of the conductor, and shielding material covering the solid conductor except with a gap in coverage centrally located at a portion of the solid conductor that spans over the base portion.

The partial region may include a middle region of the base portion.

Other technical features may be readily apparent to one skilled in the art from the following figures, descriptions, and claims.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates an embodiment of an example electromagnetic imaging (EMI) system configured with ferrite-loaded, shielded half-loop antennas;

FIG. 2 is schematic diagram that illustrates an embodiment of a measurement system used in the EMI system of FIG. 1;

FIG. 3 is a schematic diagram that illustrates issues with scattering parameter measurements and antennas that the example ferrite-loaded, shielded half-loop antennas seek to address;

FIGS. 4A-4C are schematic diagrams that illustrate various views of an embodiment of a ferrite-loaded, shielded half-loop antenna that is used in the EMI system of FIG. 1;

FIG. 5A is a logical flow diagram that illustrates an embodiment of an example EMI process;

FIG. 5B is a block diagram that illustrates an example computing device that implements certain functionality of the EMI process of FIG. 5A; and

FIG. 6 is a flow diagram that illustrates an embodiment of a method of electromagnetic imaging implemented by the EMI system of FIG. 1.

### DETAILED DESCRIPTION

Illustrations presented herein are not meant to be actual views of any particular storage container, cable assembly, component, or system, but are merely idealized representations that are employed to describe embodiments of the disclosure. Additionally, elements common between figures may retain the same numerical designation for convenience and clarity.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” “outer,” “inner,” etc., is used for clarity and convenience in understanding the disclosure and accompanying drawings, and does not connote or depend on any specific preference or order, except where the context clearly indicates otherwise. For example, these terms may refer to an orientation of elements of a sensor node, a cable, and/or a cable assembly as illustrated in the drawings. Additionally, these terms may refer to an orientation of elements of a sensor node, a cable, and/or a cable assembly when utilized in a conventional manners.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise. For example, these terms may refer to an orientation of elements of a dual linear delta assembly and/or linear delta system when utilized in a conventional manner. Furthermore, these terms may refer to an orientation of elements of a dual linear delta assembly and/or linear delta system when as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “and/or” includes any and all combinations of one or more of the associated listed items.

In one embodiment, a method implemented by an electromagnetic imaging system for imaging material within a metal container, the method comprising: transmitting to, and receiving signals from, a plurality of antennas attached to an interior wall of the metal container, the signals delivered over a plurality of channels, each of the plurality of antennas comprising a ferrite loaded, shielded half-loop antenna; measuring a plurality of scattering parameters (S-parameters) for all of the plurality of channels; calibrating the measurements; and providing an image of the material using an inversion algorithm based on the calibrated measurements.

Certain embodiments of an electromagnetic imaging (EMI) system configured with ferrite-loaded, shielded half-loop antennas and associated methods are disclosed that provide for improved performance over such systems that use conventional shielded half-loop antennas. In one embodiment, the EMI system comprises a measurement system that includes a Vector Network Analyzer (VNA) and a plurality of antennas and switching circuity for use in conjunction with measuring material properties (e.g., moisture content) in containers (e.g., grain in storage containers or bins). In one embodiment, the ferrite-loaded, shielded half-loop antennas are attached to the interior walls of the container and coupled to the VNA through the switching circuitry, enabling the measurement, among a plurality of channels, of Scattering parameters (S-parameters). In the embodiments disclosed herein, the VNA comprises a partial VNA, which limits the measurements to S11 and S21 parameters for each measurement path. In one embodiment, each ferrite-loaded, shielded half-loop antenna comprises a thin base portion and a half loop comprising a shielded conductor with a central gap in the shielding. The half loop bridges or extends over a small portion (e.g., middle portion) of the base portion and attaches to the interior metallic walls of the container. The interior walls serve as a ground plane for the ferrite-loaded, shielded half-loop antenna.

Digressing briefly, shielded half-loop antennas (SHLAs) have been used in grain storage bin EMI systems in the past, and measure the surface current (proportional to the magnetic field tangential to the bin wall behind the antenna). One shortcoming with existing SHLAs is that they have a very high S11 parameter (on the order of −1 or −2 dB), owing to poor antenna impedance mismatch that is at least partly due to the inability to deploy matching circuitry for each antenna inside the bin and the fact that such circuitry, even if deployed, narrows the bandwidth of what is ordinarily implemented as a wide band EMI system. In certain embodiments of an EMI system configured with ferrite-loaded, shielded half-loop antennas, the ferrite loading provides an improvement upon the existing SHLA design and creates an antenna that is better matched, leading to an improved signal-to-noise ratio for EMI in grain bins (i.e., higher |S21) while maintaining wide band operations.

Having summarized certain features of an EMI system with ferrite-loaded, shielded half-loop antennas of the present disclosure, reference will now be made in detail to the description of an EMI system with ferrite-loaded, shielded half-loop antennas as illustrated in the drawings. While an EMI system with ferrite-loaded, shielded half-loop antennas will be described in connection with a partial VNA system that measures properties of grain, there is no intent to limit it to the embodiment or embodiments disclosed herein. For instance, certain features of an EMI system with ferrite-loaded, shielded half-loop antennas may be used in any multi-port measurement system where only the S11 and S21 parameters of each measurement path are measured, and/or for material other than grain (e.g., granular material or fluid) as long as such contents reflect electromagnetic waves. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description, and that different embodiments described herein may be combined in any combination.

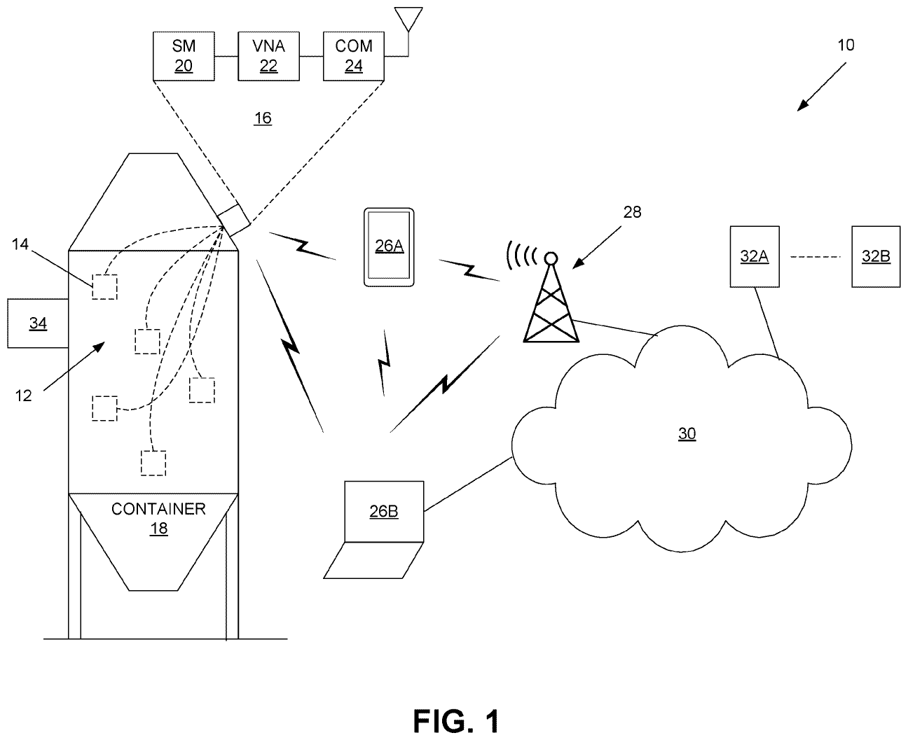

FIG. 1 is a schematic diagram that illustrates an embodiment of an example EMI system 10 that is configured with ferrite-loaded, shielded half-loop antennas. It should be appreciated by one having ordinary skill in the art in the context of the present disclosure that the EMI system 10 is one example among many, and that some embodiments of an EMI system may be used in environments with fewer, greater, and/or different components than those depicted in FIG. 1. The EMI system 10 comprises a plurality of devices that enable communication of information throughout one or more networks. The depicted EMI system 10 comprises an antenna array 12 comprising a plurality of ferrite-loaded, shielded half-loop antennas (e.g., antenna probes) 14 and a system 16 that is used to monitor/measure material within a metal container 18 and uplink with other devices to communicate and/or receive information. The container 18 is depicted as one type of grain storage bin (or simply, grain bin or bin), though it should be appreciated that containers of other geometries, for the same or other material (e.g., grain or other material), with a different arrangement (side ports, etc.) and/or quantity of inlet and outlet ports, may be used in some embodiments. As is known, electromagnetic imaging uses active transmitters and receivers of electromagnetic radiation to obtain quantitative and qualitative images of a complex dielectric profile of an object of interest (e.g., here, the material or grain).

As shown in FIG. 1, multiple antenna probes 14 of the antenna array 12 are mounted along the interior of the container 18 in a manner that surrounds the contents of the container 18 to effectively collect the scattered signal. The interior, metal walls of the container 18 serve as a ground plane for the antennas 14. Each transmitting antenna probe is polarized to excite/collect the signals scattered by the material. That is, each antenna probe 14 illuminates the material while the receiving antennas probes collect the signals scattered by the material. In one embodiment, the system 16 comprises a switch module (SM) 20, a vector network analyzer (VNA) 22, and a communications module (COM) 24. The antenna probes 14 are connected (via cabling, such as coaxial cabling) to the switch module 20. The switch module 20 is coupled to the VNA 22. The VNA 22 is coupled to the communications module 24. The VNA 22 comprises electromagnetic transceiver circuitry that generates radio frequency (RF) signals. The RF signals are transmitted through, and switched by, the switch module 20, to the antennas 14 of the antenna array 12 that are connected to the switch module 20 via cabling. The switched RF signals are used to excite the antennas 14 for imaging of the contents of the container 18. The switch module 20 switches between the transmitter/receiver pairs. The reflected signal is received by the VNA 22, via the switch module 20 (and cabling), where the VNA 22 is used to measure scattering parameters (S-parameters) corresponding to the electromagnetic fields generated at the antennas 14 and used to image the material stored in the container 18. In effect, the VNA 22 and switch module 20 enables each antenna probe 14 to deliver RF energy to the container 18 and collect the RF energy from the other antenna probes 14. The VNA 22 is coupled to the communications module 24, which includes communications circuitry (e.g., cellular and/or radio modem), the communications module 24 configured to communicate the measurements performed by the VNA 22 to, in some embodiments, a remote network for data processing and analysis. As the arrangement and general operations of the antenna array 12 and system 16 are known, further description is omitted here for brevity, except as to the specifics of the ferrite-loaded, shielded half-loop antennas. Additional information may be found in the publications “Industrial scale electromagnetic grain bin monitoring”, Computers and Electronics in Agriculture, 136, 210-220, Gilmore, C., Asefi, M., Paliwal, J., & LoVetri, J., (2017), “Surface-current measurements as data for electromagnetic imaging within metallic enclosures”, IEEE Transactions on Microwave Theory and Techniques, 64, 4039, Asefi, M., Faucher, G., & LoVetri, J. (2016), and “A 3-d dual-polarized near-field microwave imaging system”, IEEE Trans. Microw. Theory Tech., Asefi, M., OstadRahimi, M., Zakaria, A., LoVetri, J. (2014).

Note that in some embodiments, the system 16 may include additional circuitry, including a global navigation satellite systems (GNSS) device or triangulation-based devices, which may be used to provide location information to another device or devices within the EMI system 10 that remotely monitor the container 18 and associated data. The system 16 may include suitable communication functionality to communicate with other devices of the environment.

The uncalibrated, raw data collected from the system 16 is communicated (e.g., via uplink functionality of the communications module 24) to one or more electronic devices of the EMI system 10, including electronic devices 26A and/or 26B. Communication by the system 16 may be achieved using near field communications (NFC) functionality, Blue-tooth functionality, 802.11-based technology, satellite technology, streaming technology, including LoRa, and/or broadband technology including 3G, 4G, 5G, etc., and/or via wired communications (e.g., hybrid-fiber coaxial, optical fiber, copper, Ethernet, etc.) using TCP/IP, UDP, HTTP, DSL, among others. The electronic devices 26A and 26B communicate with each other and/or with other devices of the EMI system 10 via a wireless/cellular network 28 and/or wide area network (WAN) 30, including the Internet. The wide area network 30 may include additional networks, including an Internet of Things (IoT) network, among others. Connected to the wide area network 30 is a computing system comprising one or more computing devices including servers 32 (e.g., 32A, . . . 32N).

The electronic devices 26 may be embodied as a smartphone, mobile phone, cellular phone, pager, stand-alone image capture device (e.g., camera), laptop, tablet, personal computer, workstation, among other handheld, portable, or other computing/communication devices, including communication devices having wireless communication capability, including telephony functionality. In the depicted embodiment of FIG. 1, the electronic device 26A is illustrated as a smartphone and the electronic device 26B is illustrated as a laptop for convenience in illustration and description, though it should be appreciated that the electronic devices 26 may take the form of other types of devices as explained above.

The electronic devices 26 provide (e.g., relay) the (uncalibrated, raw) data sent by the system 16 to one or more servers 32 via one or more networks. The wireless/cellular network 28 may include the necessary infrastructure to enable wireless and/or cellular communications between the electronics device 26 and the one or more servers 32. There are a number of different digital cellular technologies suitable for use in the wireless/cellular network 28, including: 3G, 4G, 5G, GSM, GPRS, CDMAOne, CDMA2000, Evolution-Data Optimized (EV-DO), EDGE, Universal Mobile Telecommunications System (UMTS), Digital Enhanced Cordless Telecommunications (DECT), Digital AMPS (IS-136/TDMA), and Integrated Digital Enhanced Network (iDEN), among others, as well as Wireless-Fidelity (Wi-Fi), 802.11, streaming, etc., for illustration of some example wireless technologies.

The wide area network 30 may comprise one or a plurality of networks that in whole or in part comprise the Internet. The electronic devices 26 may access the one or more server 32 via the wireless/cellular network 28, as explained above, and/or the Internet 30, which may be further enabled through access to one or more networks including PSTN (Public Switched Telephone Networks), POTS, Integrated Services Digital Network (ISDN), Ethernet, Fiber, DSL/ADSL, Wi-Fi, among others. For wireless implementations, the wireless/cellular network 28 may use wireless fidelity (Wi-Fi) to receive data converted by the electronic devices 26 to a radio format and process (e.g., format) for communication over the Internet 30. The wireless/cellular network 28 may comprise suitable equipment that includes a modem, router, switching circuits, etc.

The servers 32 are coupled to the wide area network 30, and in one embodiment may comprise one or more computing devices networked together, including an application server(s) and data storage. In one embodiment, the servers 32 may serve as a cloud computing environment (or other server network) configured to perform processing required to implement calibration and inversion. When embodied as a cloud service or services, the server(s) 32 may comprise an internal cloud, an external cloud, a private cloud, a public cloud (e.g., commercial cloud), or a hybrid cloud, which includes both on-premises and public cloud resources. For instance, a private cloud may be implemented using a variety of cloud systems including, for example, Eucalyptus Systems, VMWare vSphere®, or Microsoft® HyperV. A public cloud may include, for example, Amazon EC2®, Amazon Web Services®, Terremark®, Savvis®, or GoGrid®. Cloud-computing resources provided by these clouds may include, for example, storage resources (e.g., Storage Area Network (SAN), Network File System (NFS), and Amazon S3®), network resources (e.g., firewall, load-balancer, and proxy server), internal private resources, external private resources, secure public resources, infrastructure-as-a-services (laaSs), platform-as-a-services (PaaSs), or software-as-a-services (SaaSs). The cloud architecture of the servers 32 may be embodied according to one of a plurality of different configurations. For instance, if configured according to MICROSOFT AZURE™, roles are provided, which are discrete scalable components built with managed code. Worker roles are for generalized development, and may perform background processing for a web role. Web roles provide a web server and listen for and respond to web requests via an HTTP (hypertext transfer protocol) or HTTPS (HTTP secure) endpoint. VM roles are instantiated according to tenant defined configurations (e.g., resources, guest operating system). Operating system and VM updates are managed by the cloud. A web role and a worker role run in a VM role, which is a virtual machine under the control of the tenant. Storage and SQL services are available to be used by the roles. As with other clouds, the hardware and software environment or platform, including scaling, load balancing, etc., are handled by the cloud.

In some embodiments, the servers 32 may be configured into multiple, logically-grouped servers (run on server devices), referred to as a server farm. The servers 32 may be geographically dispersed, administered as a single entity, or distributed among a plurality of server farms. The servers 32 within each farm may be heterogeneous. One or more of the servers 32 may operate according to one type of operating system platform (e.g., WINDOWS-based O.S., manufactured by Microsoft Corp. of Redmond, Wash.), while one or more of the other servers 32 may operate according to another type of operating system platform (e.g., UNIX or Linux). The group of servers 32 may be logically grouped as a farm that may be interconnected using a wide-area network connection or medium-area network (MAN) connection. The servers 32 may each be referred to as, and operate according to, a file server device, application server device, web server device, proxy server device, and/or gateway server device.

In one embodiment, one or more of the servers 32 may comprise a web server that provides a web site that can be used by users interested in the contents of the container 18 via browser software residing on an electronic device (e.g., electronic device 26). For instance, the web site may provide visualizations that reveal permittivity (and/or moisture content) of the contents and/or geometric and/or other information about the container and/or contents (e.g., the volume geometry, such as cone angle, height of the grain along the container wall, etc.).

The functions of the servers 32 described above are for illustrative purpose only. The present disclosure is not intended to be limiting. For instance, functionality for performing calibration and/or pixel-based inversion may be implemented at a computing device that is local to the container 18 (e.g., edge computing), or in some embodiments, such functionality may be implemented at the electronic device(s) 26. In some embodiments, functionality for performing calibration and/or pixel-based inversion described herein may be implemented in different devices of the EMI system 10 operating according to a primary-secondary configuration or peer-to-peer configuration. In some embodiments, the system 16 may bypass the electronic devices 26 and communicate with the servers 32 via the wireless/cellular network 28 and/or the wide area network 30 using suitable processing and software residing in the system 16.

Note that cooperation between the electronic devices 26 (or in some embodiments, the system 16) and the one or more servers 32 may be facilitated (or enabled) through the use of one or more application programming interfaces (APIs) that may define one or more parameters that are passed between a calling application and other software code such as an operating system, a library routine, and/or a function that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer employs to access functions supporting the API. In some implementations, an API call may report to an application the capabilities of a device running the application, including input capability, output capability, processing capability, power capability, and communications capability.

Note that reference to the EMI system 10 may refer to all or a portion of the components depicted in FIG. 1 in some embodiments. For instance, in one embodiment, the EMI system 10 may include a single computing device (e.g., one of the servers 32 or one of the electronic devices 26, or an edge computing device), and in some embodiments, the EMI system 10 may comprise the container 18, the antenna array 12, the system 16, and one or more of the server(s) 32 and electronic devices 20, or in some embodiments, the antenna array 12, the system 16, and one or more of the server(s) 32 and electronic devices 20. For purposes of illustration and convenience, implementation of the computational aspects of the EMI system 10 is described in the following as being implemented in a computing device that may be one of the servers 32, with the understanding that such functionality may be implemented in other and/or additional devices. Also shown in FIG. 1 is a moisture-affecting device 34 (e.g., a fan, blower, etc.), operably coupled (e.g., directly mounted, ducted, etc.) to the container 18, and that may be activated by one of the devices (e.g., server 32, electronic device 26) based on a determination of the moisture content within the container 18 (e.g., if there is too much moisture in the grain). Though a single moisture-affecting device 34 is shown, there may be a plurality of such devices.

In one example operation, a user (via the electronic device 26) requests measurements of the contents of the container 18. This request is communicated to the system 16. In some embodiments, the triggering of measurements may occur automatically based on a fixed time frame or based on certain conditions or based on detection of an authorized user (electronic) device 26. In some embodiments, the request may trigger the communication and/or retrieval of measurements that have already occurred. The system 16 activates (e.g., excites) the antenna probes 14 of the antenna array 12, such that the system (via the transmission of signals and receipt of the scattered signals) collects a set of raw, uncalibrated electromagnetic data at a set of (a plurality of) discrete, sequential frequencies (e.g., 10-100 Mega-Hertz (MHz), though not limited to this range of frequencies nor limited to collecting the frequencies in sequence). In one embodiment, the uncalibrated data comprises S-parameter measurements (which are used to generate a background model or information as described below).

As is known, S-parameters are ratios of voltage levels (e.g., due to the decay between the sending and receiving signal). Though S-parameter measurements are described, in some embodiments, other mechanisms for describing voltages on a line may be used. For instance, power may be measured directly (without the need for phase measurements), or various transforms may be used to convert S-parameter data into other parameters, including transmission parameters, impedance, admittance, etc. Since the uncalibrated S-parameter measurement is corrupted by the switching module 20 and/or varying lengths and/or other differences (e.g., manufacturing differences) in the cables connecting the antenna probes 14 to the system 16, it is important that calibration be implemented to remove switching, cable, and antenna effects from the S-parameter measurements as they corrupt the desired signal used for inversion. In some embodiments, de-embedding may be performed for the switching and cable effects. The system 16 communicates (e.g., via a wired and/or wireless communications medium) the uncalibrated (S-parameter) data to the electronic device 26, which in turn communicates the uncalibrated data to the server 32. At the server 32, EMI processing (e.g., calibration, inversion) are performed as explained further below.

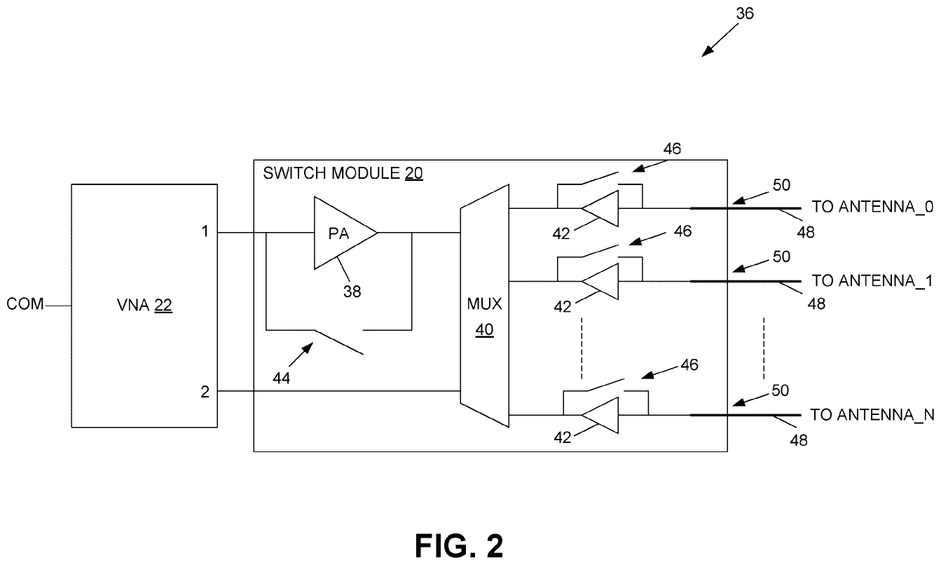

FIG. 2 is a schematic diagram of an embodiment of a measurement system 36. The measurement system 36 comprises the VNA 22 and the switch module 20 with ports enabling cabling (e.g., coaxial cables) to connect to the plurality of antennas 14 of the antenna array 12 (FIG. 1). The antennas 14 and container 18 are omitted here to avoid obfuscating certain features relevant to the measurement system 36. In other words, the measurement system 36 may comprise the VNA 22, the switch module 20, the antennas 14, and the container 18 shown in FIG. 1. The VNA 22 comprises a radio frequency (RF) signal source that operates according to a frequency range (e.g., 1-1300 mega Hertz (MHz), though not limited to this range), and comprises two ports, Port 1 and Port 2 for transmitting and receiving electromagnetic signals. The VNA 22 also measures the electromagnetic fields reflected from the antennas 14. The VNA 22 is a partial VNA, meaning that the VNA 22 measures only a subset of the S-parameters, namely, S11 and S21 parameters. As VNAs (and partial VNAs) are generally known in the industry, further discussion of the same is omitted here for brevity.

The switch module 20 comprises a power or transmission amplifier 38, a 2 to N multiplexer (MUX) 40, and a plurality of receive amplifiers 42 (e.g., low noise amplifiers). The power amplifier 38 is depicted as connected between Port 1 of the VNA 22 and the MUX 40. A switch 44 is arranged in parallel with the power amplifier 38. The MUX 40 is connected on the 2-port side to the parallel arrangement of the power amplifier 38 and the switch 44, and Port 2 of the VNA 22. On the N-port side of the MUX 40, the MUX is connected to the plurality of (N) receive amplifiers 42, which are each connected between the MUX 40 and cabling (coaxial cabling) 48 that connects, through ports 50 of the switch module 20, to the plurality of antennas 14 (e.g., antenna_0, antenna_1, . . . antenna_N, actual antennas not shown, wherein one embodiment, N equals 24, though other quantities of antennas may be used for an antenna array 12 in some embodiments). Each of the plurality of receive amplifiers 42 are arranged in parallel with a switch 46.

The antennas 14 are attached to the interior wall of the container 18 to enable the transmission and measurement of electromagnetic waves. The measured signals are sent through the cables 48 and switch module 20 (to be measured by the VNA 22). The switch module 20 provides different channels to connect the VNA 22 to each antenna 14. A channel, as used in the disclosure, refers to the signal path taken from signal transmission from the VNA 22 to signal reception at the VNA 22, and includes the path taken through the switch module 20, the cabling 48, and the antennas 14 and container 18. In an example operation, the VNA 22 makes measurements by comparing the signal transmitted out of Port 1 of the VNA 22 to the received signal received at Port 1 (S11) and Port 2 (S21). When a channel is transmitting, the power amplifier 38 is engaged (e.g., turned or toggled on), and the signal connection is completed through the MUX 40, bypasses the receive amplifier 42 via the switch 46 (hence toggling the receive amplifier off), and reaches an antenna 14. When receiving, the signal follows the path through the receiver amplifier 42, through the MUX 40, and to the Ports 1 and 2. The standard S11 and S21 S-parameter measurements are taken between every antenna pair. In one example implementation, there may be twenty-four antennas 14 used, which results in twenty-four S11measurements, and five hundred fifty-two S21 measurements. Note that the quantity of twenty-four is merely for illustrative and non-limiting purposes, and that other quantities may be used.

The S11 measurement may take the path of Port 1 from the VNA 22, through the switch module 20 and cabling 48 to antenna_0, and then reflected back through the cabling 48, switch module 20, and to Port 1. For an S21 measurement, the signal may go from Port 1 of the VNA 22, through the switch module 20, to antenna_0, triangle, to another antenna (e.g., antenna_1 as it travels through the material of the storage container 18), and back through the switch module 20 to Port 2. S21 may be based on the signal transmitted from Port 1 and received at Port 2. The S21 parameter is used in the inversion algorithm as explained below.

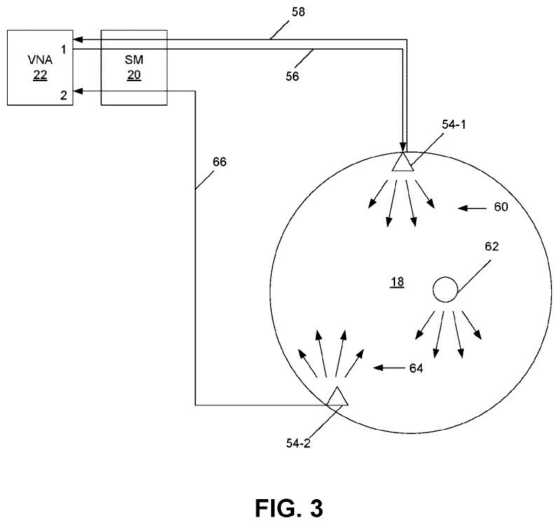

Referring to FIG. 3, shown is the VNA 22 and the switch module 20 used to transmit signals to, and receive signals from shielded half-loop antennas 54 (two shown to illustrate operations), to image material in the container 18 (shown in overhead, plan view), including object 62 (e.g., moisture regions, spoiled grain, or generally, object or region of interest). In the example illustrated in FIG. 3, the antennas 54 (e.g., 54-1 and 54-2) are described as either standard, shielded half-loop antennas or the same with ferrite-loading, depending on the context, to illustrate shortcomings with the standard antennas 14 and how the ferrite-loaded versions address these shortcomings. The VNA 22 generates and transmits from Port 1 a signal via the switch module 20 (and cabling, not shown) to antenna 54-1 via path 56. In conventional EMI systems using shielded half-lop antennas (without ferrite loading), because of the mismatches at the antenna 54-1, a significant portion (e.g., 98%) of the signal is reflected back via path 58, leaving a very small amount (strength) of signals 60 to interrogate the material in the container 18 (e.g., 2% of the signal). Note that the percentage of signals described herein is merely for illustration, and that different signal percentages transmitted and reflected may be encountered depending on the particular circumstances/environment. This transmission to, and reflection from, Port 1 according to paths 56 and 58 corresponds at the VNA 22 to an S11 parameter measurement, as is known (or in general, Syy or Sxx). The signals 60 that reach the material impinge on objects (e.g., object 62) and become scattered to created scattered fields in multiple directions, some of which reach the antenna 54-2. The signal that impinges on the antenna 54-2 also gets reflected 64 due to the poor mismatch of the regular shielded half-loop antenna 54-2, resulting in an even smaller amount of signal (e.g., 0.1%) returning back along path, through switch module 20 and to Port 2 of VNA 22 (e.g., S21 measurement). Thus, the poor mismatches at shielded, half-loop antennas 54-1 and 54-2 results in a weak signal that reaches the material because of high reflectivity at antenna 54-1 (and thus high S11 measurement) and an even weaker signal that reaches the Port 2 from antenna 54-2 (due to high reflectivity back into the material in the container 18).

If the shielded half-loop antennas 54-1 and 54-2 are replaced with ferrite-loaded, shielded half-loop antennas, then the ferrite serves the function of a matching circuit (absent in the example above for the regular, shielded half-loop antennas), resulting in a greater impedance match between antennas. Accordingly, instead of, say, 98% of the signal being reflected back to Port 1 from antenna 54-1, only perhaps 50-70% of the signal is reflected back, resulting in more of the signal that reaches the material in the container 18 (e.g., 50-30% reaching the other antenna 54-2), which results in a stronger signal at Port 2 (for the S21 measurement).

Explaining further, EMI systems generally have a noise floor. If Syx (e.g., the S-Parameter measured from standard, shielded half-loop antennas 54) was plotted against frequency, the signal strength along path 66 would be close to the noise floor, resulting in a small signal-to-noise ratio or SNR where Syx is close to the noise floor (and hindering the ability to detect the signal at Port 2 relative to signal noise). A small SNR for this signal makes it difficult for the imaging algorithm to recover the image of objects that are within the container 18. For instance, when the images are created, artifacts may be introduced, including false negatives/positives, etc., which may cause a degradation in EMI performance. However, if the antennas 54 are implemented as ferrite-loaded, shielded half-loop antennas, the Syx versus frequency plot reveals an improvement in Syx (greater separation from the noise floor) since the received signal at Port 2 is stronger (e.g., due to better matching), resulting in a better SNR for inputs to the inversion algorithm.

An additional benefit to using ferrite-loaded, shielded half-loop antennas involves the operational frequency. Generally in antenna design, optimization is sought in reflection (e.g., how much of the signal is reflected and how much reaches the region of interest). If the reflection coefficient (e.g., Syy along the y-axis in, say, decibels, where yy may be 11, 22, etc.) is plotted against frequency (along the x-axis), for most of the frequencies, Syy is at approximately zero decibels (dB) e.g., the signals that are reflected back) except at the frequencies the antenna is designed for (to radiate into the region of interest, such as the material in the container 18), where the decibel level falls to or below about −10 decibels. Thus, the reflection is a design parameter that is optimized to achieve a maximum amount of signal that radiates to the region of interest at the resonance frequency or the operational frequency of the antenna.

In regular shielded, half-loop antennas, the S11 plot for most of the frequencies is approximately zero (e.g., about 95% of the signal is reflected), with at best −1 dB to −2 dB, and to approximately −10 dB around the operational frequency, leaving a small amount of signal available for the S21 measurement. For the S21 plot (e.g., Syx or generally, Sxy) for a regular, shielded half-loop antenna, which is the signal that goes from the path involving Port 1, through the material of the container, and back to Port 2, at resonance, a good portion leaves the antenna and goes through the medium, and for the rest of the frequencies, the signal is much weaker (e.g., approximately −100 dB).

When ferrite loading is added, similar to any matching circuit, the resonances are shifted to lower frequencies with a greater amount of the signal reaching the medium (e.g., experimentally, signal strength is increased about 20 dB). The greater signal strength may provide for higher SNR (and accordingly, improved imaging). The lowering of the resonance frequencies also has an advantage in operations of the imaging algorithm. For instance, when performing imaging, the domain is discretized into discretized elements (e.g., tetrahedral elements). As the frequency is increased, the number of discretized elements is increased as well, which makes computations more difficult to solve (and becomes more computationally expensive). Further, as the frequency increases, the losses in the medium and hence signal decay are more pronounced. Generally, as the frequency is reduced, the size of an antenna for the comparable performance at higher frequencies should increase. With ferrite loading (or matching circuits in general), there is no need to increase the size of the antenna as the frequency is lowered.

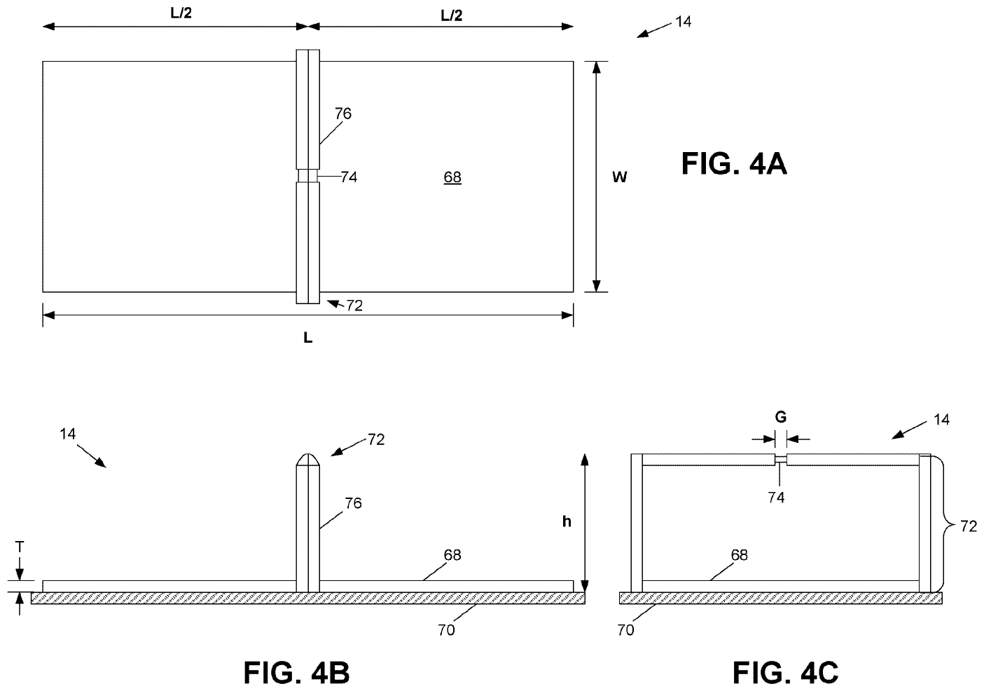

Before proceeding with the description of the ferrite-loaded, shielded half-loop antenna 14 described in FIGS. 4A-4B, a brief explanation of an additional motivation in the design is as follows. In general, designing a resonant shielded half-loop antenna at high frequency (HF) band (e.g., 3-30 MHz band) is somewhat similar to other antennas, starting with the existing antenna design (see, e.g., M. Asefi, et. al. “Surface-current measurements as data for electromagnetic imaging within metallic enclosures”, referenced above), which is a symmetric antenna with two ports and a small gap at the middle of the outer shield of the loop, made of semi rigid cable (e.g., RG405), and analyzing the impedance, where materials are added to better match the antenna. When observing the measured impedance of existing shielded half-loop antennas installed in a metal grain bin, it is noted that the imaginary part of the input impedance changes rapidly in resonant areas and the real part of the input impedance is far from matched (e.g., target of 50 Ω) either at resonance or at non-resonance frequencies. For instance, at a target frequency range of 250-300 MHz, the existing SHLA is mainly capacitive (I(Z_{SHLA})≈−110 Ω) and real part is (Re(Z_{SHLA})≈110 Ω).

Using ferrite cores is one way to increase the real part of impedance in loop antennas (see, e.g., the Harrington article referenced above). Also, the high permeability of the ferrite increases inductivity of the existing shielded half-loop antennas. As grain loading and unloading can be mechanically destructive on structures in a bin, the ferrite material is placed under the half-loop on the interior, metal wall of the bin. Using data sheet parameters for existing ferrite (e.g., such data may be found in various references, including the Ferroxcube website), and based on the obtained values for its permittivity in the literature (e.g., see Xu, Jianfeng et. al. “Complex permittivity and permeability measurements and finite-difference time-domain simulation of ferrite materials.” IEEE trans. on electromagnetic compatibility (2010)), a size of approximately 100 mm×50 mm is found through optimization via simulation (where commercially available ferrite may be found in or around this range). In simulation, it has been found that the ferrite-loaded, shielded half-loop antenna performs as follows: (I(Z_{FL}_{^{SHILA}}=0 Ω) occurs at a resonance frequency of 260 MHz, and at this frequency the real part of the impedance is 400. This impedance behavior gives a bandwidth of BW≈60 MHz for a voltage standing wave ratio VSWR<2:1. The antenna pattern, which should approximate a magnetic dipole, has an omni-directional pattern with a null broadside to the loop.

In comparing actual to simulated measurements, and using a scaled grain bin partially filled with wheat, it was observed that resonance for the ferrite-loaded, shielded half-loop antenna occurs at approximately 265 MHz, which is a reasonable match to the simulated value given variations in materials and dimensions. The S21 parameters were measured (e.g., between two antennas on opposite sides of the bin), with measurements for standard, shielded half-loop antennas and those that are ferrite-loaded, and in the frequency range of 200-400 MHz, the ferrite-loaded, shielded half-loop antenna has about 20 dB more signal than the regular, shielded half-loop antenna (non-ferrite loaded), which means the received signal is approximately one-hundred (100) times higher in power and ten (10) times higher in voltage amplitude over this band.

As should be appreciated by one having ordinary skill in the art, these design criteria and performance parameters are for illustration based on the specific implementation described herein, and that in some implementations, other design criteria may be used that results in different performance parameters that meet the design objectives.

Attention is now directed to FIGS. 4A-4C, which illustrate various views of the ferrite-loaded, shielded half-loop antenna 14 that is used in the EMI system 10 of FIG. 1 and has exhibited the performance described above. FIG. 4A shows an overhead plan view, FIG. 4B shows a side elevation view, and FIG. 4C shows a front elevation view. The ferrite-loaded, shielded half-loop antenna 14 comprises a base portion 68. In one embodiment, the base portion 68 consists of a solid slab of ferrite material. In the depicted embodiment, the base portion 68 is comprised of a rectangular geometry with a length (L), width (W), and thickness (T). In FIGS. 4B-4C, the base portion 68 is shown adjacent to, and in contact with, a metal interior surface 70 of the container 18. The metal interior surface serves as the ground plane for the antenna 14. The ferrite-loaded, shielded half-loop antenna 14 further comprises a half loop 72, which includes a solid conductor 74 and a shielded material 76 that covers the solid conductor 74 except at a gap (G) located centrally to the half loop 72. The half loop 72 extends over the base portion 68 and straddles each end of the base portion 68 to connect to the metal interior surface 70 at opposing ends of the half loop 72. The connection may be achieved in one of numerous ways. For instance, the connection to the interior surface 70 may be achieved magnetically (e.g., where the base of the antennas 14 are comprised of strong magnets), or in some embodiments, fixedly attached. For instance, the antennas 14 may be bolted (e.g., the base of the antenna is bolted to the bin surface). Note that the shielding does not necessarily need to be directly connected to the base. The ferrite may be glued or screwed to the base as well, and does not necessarily require a direct connection to the shield. Accordingly, the half loop 72 comprises a height (h) relative to the metal interior surface 70 and a width slightly wider than the base portion 68 to enable connection at each end of the half loop 72 to the metal interior surface 70. The space between a top surface of the base portion 68 and the portion of the half loop 72 extending over the base portion 68 is occupied by air, though in some embodiments, a non-air dielectric may be used. In effect, the half loop 72 extends or bridges over the base portion 68 along a partial portion (across the width) of the base portion 68, and in one embodiment, approximately midway (L/2) along the length of the base portion 68. Some example dimensions (in millimeters, or mm) for the ferrite-loaded, shielded half-loop antenna 14 are as follows: length (100), width (56), height (22), thickness (1.1), and gap (0.5). Note that the geometries and dimensions described above and illustrated in FIGS. 4A-4C are illustrative, and one skilled in the art should understand and appreciate within the context of the present disclosure that other geometries for the various components of the ferrite-loaded, shielded half-loop antenna 14 and/or sizes/dimensions or relative sizes may be used in some embodiments.

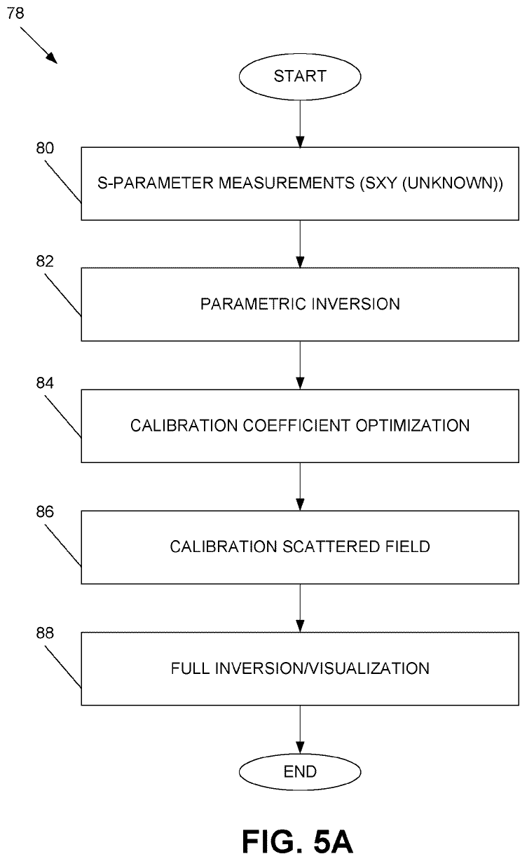

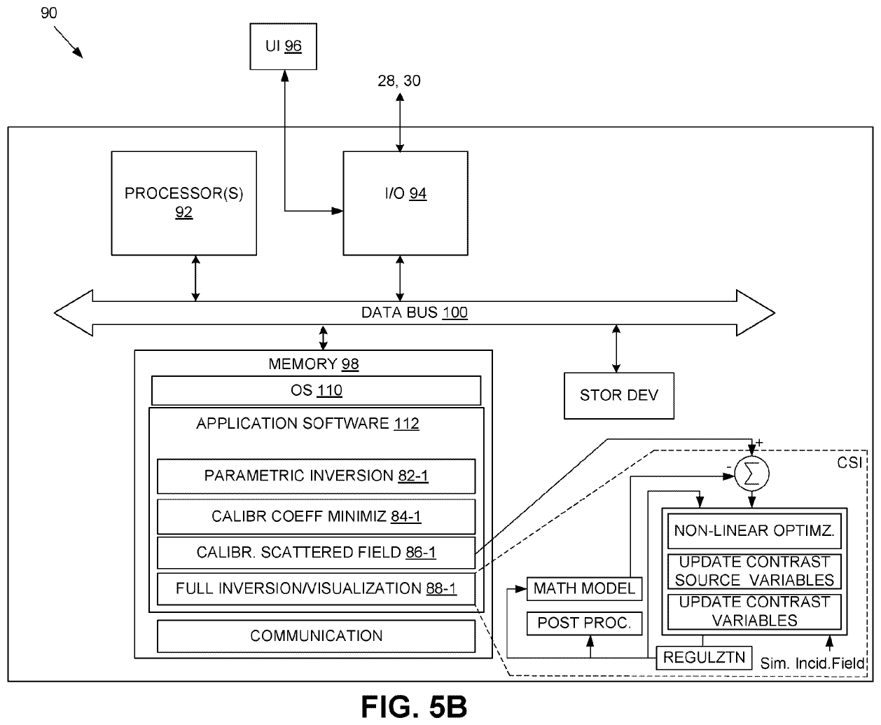

Having described certain embodiments of a ferrite-loaded, shielded half-loop antenna 14 and an EMI system 10 that deploys such antennas, attention is directed to FIG. 5A, which shows an embodiment of an example EMI process 78. The EMI process 78 may be implemented in the EMI system 10 of FIG. 1, with the calibration and inversion implemented in one or more devices, such as a the server(s) 26. Blocks 80-88 in FIG. 5A collectively provide a logical flow diagram and that are intended to represent modules of code (e.g., opcode, machine language code, higher level code), fixed or programmable hardware, or a combination of both that implement the functionality or method step of each block, where all blocks may be implemented in a single component or device or implemented using a distributed network of components or devices.

The process 78 comprises S-parameter measurements (80), parametric inversion (82), calibration coefficients optimization (84), calibrated scattered field (86), and full inversion/visualization (88). For S-parameter measurements, raw data from bin monitoring is measured by the VNA 22 through transmission and reception of signals through the switch module 20, cables 48, and antennas 12 installed in the interior of the container 18. The raw data is communicated via the communications module 24 to a computing device, such as a server or servers 32, where in one embodiment, blocks 82-88 are implemented.

In one embodiment, using a set of (S21 parameter, which is a subset of Syx or Sxy input to the algorithms) measurements

$${S}_{xy}^{unknown} ,$$

one initial step comprises obtaining a simple background model from which scattered fields may be generated. Once a background model has been determined, calibration for system/model effects (e.g., different cable lengths) can be implemented. More particularly, and referring to block 82, the process 78 performs a phaseless parametric inversion with the raw measurements to obtain the known background model, though in some embodiments, measurements at different times may be taken to obtain a known state of the grain (e.g., homogenous) and a changed state of the grain. Note that in some embodiments, further steps not shown may include a de-embedding step for removing the effects of the cabling and measuring system. Further, though a phaseless parametric inversion is described herein, in some embodiments, both magnitude and phase may be used. Once a background model has been determined, calibration for system/model effects can be implemented. The known background model consists of the grain height at the bin wall h, cone angle Θ, and bulk average complex-valued permittivity ε=εr−jεi. Obtaining the known background model is achieved in one embodiment via phaseless parametric inversion on the parameters p=(h, Θ, ε). To determine these parameters,

$$raw {S}_{xy}^{unknown}$$

measurements are taken and then the following cost functional is minimized according to Eqn. 1:

$$\underline{p} = \begin{matrix}{argmin}_{∼} \\ \underline{p}\end{matrix} {Σ}_{x , y} {‖ \vert {α}_{x} ( \tilde{\underline{p}} ) {S}_{xy}^{unknown} \vert - \vert {H}_{xy} ( \underline{\tilde{p}} ) \vert ‖}_{2}^{2} , \qquad ( 1 )$$

where ax is a per-transmitter factor used to scale average signal levels between forward-solver-generated estimate fields H_{xy}(p) and the VNA measurements

$${S}_{xy}^{unknown}$$

given by Eqn. 2 below:

$${α}_{x} ( \underline{p} ) = ( {Σ}_{y} \vert {H}_{xy} ( \underline{p} ) \vert ) / ( {Σ}_{y} \vert {S}_{xy}^{unknown} \vert ) . \qquad ( 2 )$$

By using phaseless data and minimizing this objective function, parameters p are obtained, which provide a bulk estimate of the bin (container 18) contents.

Referring to block 84, the process 78 further comprises determining calibration coefficients. For instance, the process 78 calibrates the

$${S}_{xy}^{unknown}$$

data. The calibration uses a set of per-channel calibration coefficients. For instance, in the case of a grain bin with twenty-four (24) antennas, twenty-four (24) calibration coefficients cx are sought. Notation is simplified by representing these coefficients as a diagonal calibration matrix C (e.g., along the diagonal, c₁, c₂, . . . c_{N}), where N is the number of antennas or antenna probes (i.e. transmit/receive channels) and cx is the (complex) calibration coefficient for channel x used to capture channel loss and phase shift. The diagonal calibration matrix C is calculated according to Eqn. 3 below:

$$C = \begin{matrix}argmin \\ \tilde{C}\end{matrix} {‖ \tilde{C} {S}^{unknown} \tilde{C} - H ( \underline{p} ) ‖}_{2}^{2} , \qquad ( 3 )$$

where S^{unknown} is the entire matrix of

$${s}_{xy}^{unknown}$$

(H (p) is defined analogously). The quantity

$${( \tilde{C} {S}^{u n k n o w n} \tilde{C} )}_{xy} = {c}_{x} {S}_{xy}^{unknown} {c}_{y}$$

and the coefficients cₓ and c_{y} serve to account for cable loss and phase shifts along the channels x and y in the measurement path that are not accounted for in the forward model used to generate H (p). This per-channel calibration model is justified, since a significant portion of signal modification due to the measurement system is due to a magnitude and phase shift through each transmit/receive channel. Further, this channel phase shift and loss are the same whether the channel is in a transmit mode or receive mode. In one embodiment, coefficients are obtained using L2 norm minimization with raw measurements and the result from the parametric inversion 82. In general, the inputs to the example minimization formula of Eqn. 3 comprise the result of a bulk solve (e.g., which outputs grain height, cone angle, moisture content) and the measured data itself (e.g., complex field data or complex S-parameters). In some embodiments, other minimization techniques known to those having ordinary skill in the art may be used. Note that in some embodiments, cross-channel signal leakage (that occurs primarily inside the switch module 20) may be ignored, since a switch may be used that is specifically designed (e.g., use of ground pins, reducing the signal to ground ratio, etc.) to minimize cross-channel signals. The calibration matrix effectively assumes that each transmit/receive channel can be viewed as a lossy transmission line (not a full two-port device between the VNA and the antenna). The diagonal C-matrix also takes into account the antenna factor (that compensates for the change between the field and voltage ratio measurements).

Referring to logical block 86, the process 78 determines the calibrated scattered measurements. That is, once the per-channel calibration coefficients have been calculated, the calibrated scattered field measurements

$${H}_{xy}^{sct , cal}$$

are computed according to Eqn. 4 below:

$${H}^{sct , cal} = {CS}^{u n k n o w n} - H ( \underline{p} ) . \qquad ( 4 )$$

The calibrated scattered fields are summarized as the channel compensated difference between a single set of measurements S^{unknown} and a simple parametric model corresponding to those same measurements. Once calibration has been applied to produce H^{sct,cal}, an inversion algorithm (block 88) can be applied to detect hotspots (e.g., areas of high moisture content) in the material of the container 18 (e.g., the stored grain). In one embodiment, a parallel 3D Finite-Element Contrast Source Inversion Method (FEM-CSI) may be used. Further information on CSI may be found in published literature, including “Full vectorial parallel finite-element contrast source inversion method” by A. Zakaria, I. Jeffrey, and J. Lovetri, published in 2013 in Prog. Electromagn. Res., vol. 142, pp. 463-384. Note that in some embodiments, a data driven approach may be used (e.g., where learning is used to replace an explicit, a priori known forward model, such that a large amount of data is used to implicitly learn a forward model when solving the inversion problem).

Having described an embodiment of an EMI process 78, attention is directed to FIG. 5B, which illustrates an example computing device 90 that in one embodiment implements the blocks 82-88 of the EMI process 78 in software stored on a non-transitory computer readable medium. In one embodiment, the computing device 90 may be the server 32, though in some embodiments, the computing device 90 may be one of the electronic devices 26 or an edge computing device. Though described below as a single computing device (e.g., server 32) implementing the blocks 82-88 of the EMI process 78, in some embodiments, such functionality may be distributed among a plurality of devices (e.g., using plural, distributed processors) that are co-located or geographically dispersed. In some embodiments, functionality of the computing device 90 may be implemented in another device, including a programmable logic controller, application-specific integrated circuit (ASIC), field-programmable gate array (FPGA), among other processing devices. It should be appreciated that certain well-known components of computers are omitted here to avoid obfuscating relevant features of computing device 90. In one embodiment, the computing device 90 comprises one or more processors, such as processor 92, input/output (I/O) interface(s) 94, a user interface 96, and a non-transitory, computer readable medium comprising a memory 98, all coupled to one or more data busses, such as data bus 100. The memory 98 may include any one or a combination of volatile memory elements (e.g., random-access memory RAM, such as DRAM, and SRAM, etc.) and nonvolatile memory elements (e.g., ROM, hard drive, tape, CDROM, etc.). The memory 98 may store a native operating system, one or more native applications, emulation systems, or emulated applications for any of a variety of operating systems and/or emulated hardware platforms, emulated operating systems, etc. In the embodiment depicted in FIG. 5B, the memory 98 comprises an operating system 110 and application software 112.

In one embodiment, the application software 112 comprises the functionality of logical blocks 82-88 (FIG. 5A), including parametric inversion module 82-1, calibration coefficient minimization/optimization module 84-1, calibrated scattered field module 86-1, and full inversion/visualization module 88-1. Functionality for modules 82-1-88-1 are described above in association with FIG. 5A, and hence further description of the same is omitted here for brevity except where noted below. Memory 98 further comprises a communications module that formats data according to the appropriate format to enable transmission or receipt of communications over the networks and/or wireless or wired transmission hardware (e.g., radio hardware). In general, the application software 112 performs the functionality described in association with the logical blocks 82-88 of FIG. 5A.

The full inversion/visualization module 88-1 may comprise known pixel-based inversion (PBI) software. For instance, the full inversion/visualization module 88-1 comprises known algorithms for performing pixel-based inversion based on the outputs provided by the calibrated scattered field module 86-1, and includes contrast source inversion (CSI) or other known visualization software. For instance, FEM-CSI may be implemented, as schematically illustrated in FIG. 5B. Digressing briefly, in general, the illuminated scattered field is measured at multiple receiver locations around an object of interest on a measurement surface, the object of interest represented using complex-valued relative permittivity εᵣ(r) as a function of position, which is converted to the so-called contrast function, reproduced below as Eqn. 5:

$$X ( r ) {=}^{Δ} \frac{ε r - ε rb}{ε rb} , \qquad ( 5 )$$

which for an air background, εrb=1 simply becomes εr−1. A final goal in the full inversion process is to reconstruct the relative permittivity εr of an object of interest from measured data on measurement surface S, where generally, iterative methods are used to iterate between solving for the contrast using an assumed total-field and solving for the total field in a domain equation using an assumed contrast. In CSI, as is known, the measured scattered field data and a functional over the imaging domain are combined within an objective function that is minimized with respect to both unknowns. For instance, when the CSI cost functional is used, the CSI cost functional is formulated using the contrast sources, which vary with transmitter and the contrast, and which is constructed as the sum of normalized data-error and domain-error functionals. For each transmitter, one component of the cost function is the norm of the difference of the measured scattered field data and the calculated scattered field at the receiver locations. Assuming a finite-element forward model, computation of one functional component of the CSI cost functional involves a matrix (the inverse of an FEM matrix operator that transforms contrast source variables (w(r)=X(r)Eₜₒₜₐₗ (r)) of an imaging domain to scattered field values within a whole domain (problem domain)) and a matrix operator (transforms field values from the whole domain to receiver locations on the measurement surface S). The other functional component (sometimes referred to as a Maxwellian regularizer, formulated using the forward model) of the CSI cost functional is a functional over the imaging domain and is calculated using an FEM model of an incident field within the imaging domain as well as the contrast, X, and contrast sources w(r), where a matrix operator transforms field values from the problem domain to points inside the imaging domain. The CSI objective functional, F^{CSI}(X, w(r)) is minimized by updating the contrast sources and the contrast variables sequentially in an iterative fashion using a conjugate gradient technique. This process is generally and schematically illustrated in FIG. 5B, though known to those having ordinary skill in the art as detailed further in the referenced publication cited above. That is, as CSI is well understood in the industry, further description of the same is omitted here for brevity. Visualization may include parameter values describing permittivity (and/or other content parameters, such as moisture content) and geometric information about the contents, including the height of the grain along the container wall, the angle of grain repose, and the average complex permittivity of the grain. In some embodiments, the rendering of the color of the grain may be indicative of average grain moisture content, among other parameters.

In some embodiments, one or more functionality of the application software 112 may be implemented in hardware. In some embodiments, one or more of the functionality of the application software 112 may be performed in more than one device. It should be appreciated by one having ordinary skill in the art that in some embodiments, additional or fewer software modules (e.g., combined functionality) may be employed in the memory 98 or additional memory. In some embodiments, a separate storage device may be coupled to the data bus 100, such as a persistent memory (e.g., optical, magnetic, and/or semiconductor memory and associated drives).

The processor 92 may be embodied as a custom-made or commercially available processor, a central processing unit (CPU), graphic processing unit (GPU), or an auxiliary processor among several processors, a semiconductor based microprocessor (in the form of a microchip), a macroprocessor, one or more ASICs, a plurality of suitably configured digital logic gates, and/or other well-known electrical configurations comprising discrete elements both individually and in various combinations to coordinate the overall operation of the computing device 90.

The I/O interfaces 94 provide one or more interfaces to the networks 28 and/or 30. In other words, the I/O interfaces 94 may comprise any number of interfaces for the input and output of signals (e.g., analog or digital data) for conveyance over one or more communication mediums.

The user interface (UI) 96 may be a keyboard, mouse, microphone, touch-type display device, head-set, and/or other devices that enable visualization of the contents and/or container as described above. In some embodiments, the output may include other or additional forms, including audible or on the visual side, rendering via virtual reality or augmented reality based techniques.

Note that in some embodiments, the manner of connections among two or more components may be varied. Further, the computing device 90 may have additional software and/or hardware, or fewer software.

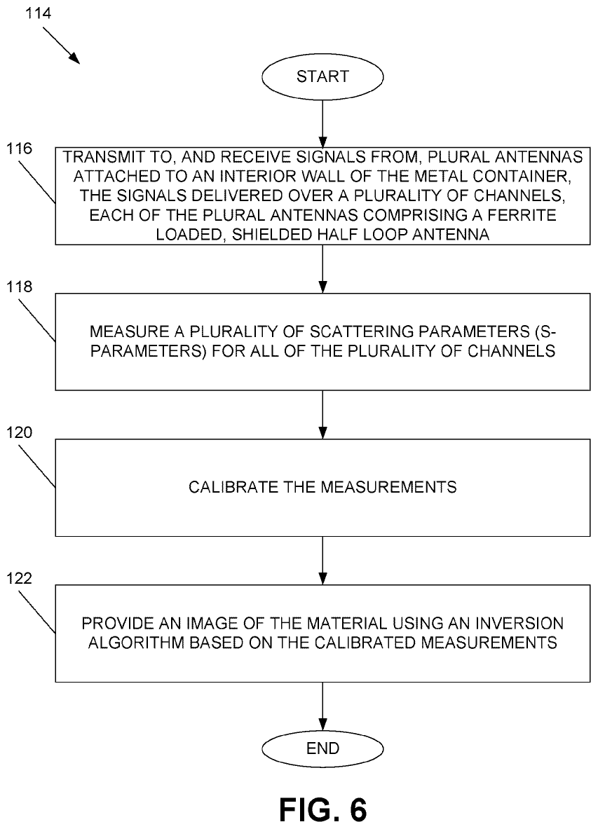

The application software 112 comprises executable code/instructions that, when executed by the processor 92, causes the processor 92 to implement the functionality shown and described in association with the processes/methods described in association with FIGS. 5A-6, and full inversion/visualization (in part via the user interface 96). As the functionality of the application software 112 has been described in the description corresponding to the aforementioned figures, further description here is omitted to avoid redundancy. In some embodiments, the application software 112 may be used to activate a moisture-affecting device (e.g., moisture-affecting device 34) based on the results of computations.

Execution of the application software 112 is implemented by the processor 92 under the management and/or control of the operating system 110. In some embodiments, the operating system 110 may be omitted. In some embodiments, functionality of application software 112 may be distributed among a plurality of computing devices (and hence, plural processors).

When certain embodiments of the computing device 90 are implemented at least in part with software (including firmware), as depicted in FIG. 5B, it should be noted that the software can be stored on a variety of non-transitory computer-readable medium (including memory 98) for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the computing device 90 are implemented at least in part with hardware, such functionality may be implemented with any or a combination of the following technologies, which are all well-known in the art: a discrete logic circuit(s) having logic gates for implementing logic functions upon data signals, an ASIC having appropriate combinational logic gates, a programmable gate array(s) (PGA), a field programmable gate array (FPGA), etc.

Having described certain embodiments of an EMI system and method, it should be appreciated within the context of the present disclosure that one embodiment of electromagnetic imaging implemented by the EMI system deployed with ferrite-loaded, shielded half-loop antennas 14 is shown in the flow diagram of FIG. 6, which in one embodiment may be performed by one or more components of the EMI system 10 depicted in FIG. 1. The method is denoted as method 114, and is implemented in one embodiment using one or more processors of a computing device or a plurality of computing devices such as computing device 90. The method 114 comprises: transmitting to, and receiving signals from, a plurality of antennas attached to an interior wall(s) of the metal container, the signals delivered over a plurality of channels, each of the plurality of antennas comprising a ferrite loaded, shielded half-loop antenna (116); measuring a plurality of scattering parameters (S-parameters) for all of the plurality of channels (118); calibrating the measurements (120); and providing an image of the material using an inversion algorithm based on the calibrated measurements (122). Note that the steps described herein have also been described in greater detail in association with the process 78 in FIG. 5A, including the measuring (e.g., block 82), calibrating (blocks 84 and 86), and imaging via inversion (block 88, and FIG. 5B), and hence description of the same here is omitted for brevity.

Any process descriptions or blocks in flow diagrams should be understood as representing logic and/or steps in a process, and alternate implementations are included within the scope of the embodiments in which functions may be executed out of order from that shown or discussed, including substantially concurrently, or with additional steps (or fewer steps), depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. As noted above, two or more of the embodiments described herein may be combined according to any combination. Many variations and modifications may be made to the above-described embodiment(s) of the disclosure without departing substantially from the scope of the disclosure. All such modifications and variations are intended to be included herein within the scope of this disclosure and protected by the following claims.

At least the following is claimed:

1. A system, comprising:
a metal container configured to store a material;
a measurement system comprising a vector network analyzer (VNA), a switch module, a plurality of cables, the metal container, and a plurality of antennas coupled to an interior wall of the metal container,
wherein the switch module is configured to switch signals transmitted to and received from the plurality of antennas via a plurality of channels,
wherein the VNA is configured to measure scattering parameters (S-parameters) of all of the plurality of channels,
and wherein each antenna of the plurality of antennas comprises a ferrite loaded, shielded half-loop antenna;
a controller operably coupled to the measurement system and comprising:
at least one processor; and
at least one non-transitory computer-readable storage medium storing instructions thereon that, when executed by the at least one processor, cause the system to:
receive measurements via the measurement system;
calibrate the received measurements; and
generate an image of the material using an inversion algorithm based on the calibrated measurements.

2. The system of claim 1, wherein the ferrite loaded, shielded half-loop antenna comprises a base portion comprised of ferrite material, the base portion adjacent to and in contact with the interior wall of the metal container.

3. The system of claim 2, wherein the interior wall of the metal container constitute a ground plane for the ferrite loaded, shielded half-loop antenna.

4. The system of claim 2, wherein the ferrite loaded, shielded half-loop antenna further comprises a solid conductor attached at each end of the conductor to the interior wall of the metal container, wherein the solid conductor spans over the base portion, separated from, and elevated above, only a partial region of the base portion by a gap extending between the two ends of the conductor.

5. The system of claim 4, wherein the partial region comprises a middle region of the base portion.

6. The system of claim 4, wherein the ferrite loaded, shielded half-loop antenna further comprises a shielding material covering the solid conductor except with a gap in coverage centrally located at a portion of the solid conductor that spans over the base portion.

7. A method implemented by an electromagnetic imaging system for imaging a material within a metal container, the method comprising:
transmitting to, and receiving signals from, a plurality of antennas attached to an interior wall of the metal container, the signals delivered over a plurality of channels, each of the plurality of antennas comprising a ferrite loaded, shielded half-loop antenna;
measuring a plurality of scattering parameters (S-parameters) for all of the plurality of channels;
calibrating the measurements; and
generating an image of the material using an inversion algorithm based on the calibrated measurements.

8. The method of claim 7, wherein the ferrite loaded, shielded half-loop antenna comprises a base portion comprising a slab of ferrite material, the base portion adjacent to and in contact with the interior wall of the metal container.

9. The method of claim 8, wherein the interior walls constitute a ground plane for the ferrite loaded, shielded half-loop antenna.

10. The method of claim 8, wherein the base portion is used for impedance matching of the plurality of antennas.

11. The method of claim 8, wherein the ferrite loaded, shielded half-loop antenna further comprises a solid conductor attached at each end of the conductor to the interior surface of the container, wherein the solid conductor spans over the base portion, separated from, and elevated above, only a partial region of the base portion by a gap extending between the two ends of the conductor.

12. The method of claim 11, wherein the partial region comprises a middle portion of the base portion.

13. The method of claim 11, wherein the ferrite loaded, shielded half-loop antenna further comprises a shielding material covering the solid conductor except with a gap in coverage centrally located at a portion of the solid conductor that spans over the base portion.

14. The method of claim 7, further comprising improving a signal to noise ratio of an S21 parameter based on the ferrite loading, the improvement over a non-ferrite loaded shield half-loop antenna for the same parameter.

15. The method of claim 7, further comprising shifting a resonance frequency lower in frequency based on the ferrite loading, the lowering of the resonance frequency relative to a resonance frequency for a non-ferrite loaded shield half-loop antenna.

16. An antenna, comprising:
a base portion comprised of ferrite material;
a solid conductor attached at each end of the conductor to the interior surface of the container, wherein the solid conductor spans over the base portion, separated from, and elevated above, only a partial region of the base portion by a gap extending between the two ends of the conductor; and
shielding material covering the solid conductor except with a gap in coverage centrally located at a portion of the solid conductor that spans over the base portion.

17. The antenna of claim 16, wherein the partial region comprises a middle region of the base portion.
